(19) United States
(12) Patent Application Publication
(10) Pub. No.: US 2019/0267816 A1
(43) Pub. Date: Aug. 29, 2019

(54) LOCAL ANALOGUE EQUILIBRATING SYSTEM FOR A SET OF DEVICES FOR STORING ELECTRICAL POWER VIA A CAPACITIVE EFFECT, ELECTRICAL INSTALLATION, TRANSPORT VEHICLE AND RECHARGEABLE STORAGE MODULE COMPRISING SUCH A SYSTEM

(71) Applicant: BLUE SOLUTIONS, Ergue Gaberic (FR)

(72) Inventor: Jean-Michel DEPOND, Quimper (FR)

(21) Appl. No.: 16/343,181

(22) PCT Filed: Nov. 15, 2017
(86) PCT No.: PCT/EP2017/079251

§ 371 Date: Apr. 18, 2019

(30) Foreign Application Priority Data
Nov. 18, 2016 (FR) 1661244

(51) Int. Cl. H02J 7/00; B60L 58/22; B60K 6/28

(52) U.S. Cl. CPC H02J 7/0016; H02J 7/0021; H02J 7/345; B60K 6/28; B60L 58/22

(57) ABSTRACT

An analogue system for balancing an electrical energy storage assembly having a plurality of capacitive effect electrical energy storage devices connected to one another in series, the system including, for each storage device, a balancing device including:
a bypass circuit for the storage device, able to be controlled between a closed state and an open state;
a first voltage comparator for controlling an open or closed state of the bypass circuit depending on a balancing voltage; and
a second voltage comparator for controlling an open or closed state of the bypass circuit depending on a switch-off voltage.

The present invention relates to an analogue balancing system for an assembly of capacitive-effect storage devices connected to one another in series. It also relates to a rechargeable electrical energy storage module, an electric or hybrid transport vehicle and a power supply installation implementing such a system.

The field of the invention is the field of systems for balancing supercapacitors that are connected in series.

### BACKGROUND

A supercapacitor stores electrical energy through a capacitive effect. The main limitation of a supercapacitor is that it operates only at a very low voltage. To achieve the desired operating voltage, the supercapacitors are placed in series in a rechargeable electrical energy storage module.

However, on account of manufacturing differences or differences in ageing, the supercapacitors of one and the same storage module only rarely charge at the same rate. In order to ensure a greater homogeneity in the voltage across the terminals of the supercapacitors in series, a balancing system is provided, in analogue form for reasons of cost, reliability, feasibility and robustness.

This analogue balancing system enables, during a charging phase, diversion of at least some of the current for each supercapacitor, on an individual basis, when the voltage across its terminals exceeds a predetermined voltage, called balancing voltage. At the end of the charging phase, if the balancing voltage is exceeded for all of the supercapacitors, this generally being the case, all of the supercapacitors are therefore bypassed.

Thus, when the charging phase is not followed immediately by a discharging phase, but by an under voltage phase or by a rest phase, each supercapacitor remains bypassed and discharges into the bypass circuit for as long as the voltage across its terminals is greater than the balancing voltage. In other words, during an under voltage phase or a rest phase separating a charging phase from a discharging phase, the supercapacitors discharge into the bypass circuit while they are not being used. A loss of energy therefore occurs, which is compensated in the case of an under voltage phase, and not compensated in the case of a rest phase, this being costly in any case and reducing the efficiency and autonomy of the supercapacitors, and therefore of the storage module.

A purpose of the present invention is to overcome these drawbacks.

Another purpose of the invention is to propose a more efficient balancing system for an assembly of capacitive-effect storage devices connected to one another in series.

It is also a purpose of the invention to propose a balancing system for an assembly of capacitive-effect storage devices in series that makes it possible to reduce, or even eliminate, energy losses and to improve the efficiency and the autonomy of said assembly.

### SUMMARY OF THE INVENTION

The invention makes it possible to achieve at least one of these aims with an analogue system for balancing a rechargeable electrical energy storage assembly comprising a plurality of capacitive-effect storage devices connected to one another in series, said system comprising, for each storage device, a balancing device including:
a bypass circuit for said storage device, able to be controlled between a closed state and an open state, and
a voltage comparator, celled first comparator, arranged to control said bypass circuit into an open or closed state, depending on the voltage on the terminals of said storage device
and on a predetermined voltage, called balancing voltage, denoted V_{eq} hereinafter;
   said system being characterized in that it further comprises, for each storage device, another voltage comparator, celled second comparator, arranged to control an open or closed state of the bypass circuit for said storage device depending on:
the voltage on the terminals of said storage device and
a predetermined voltage, called switch-off voltage, representative of a closed state of the majority, or of all, of the bypass circuits, and denoted V_{dec} hereinafter.

In particular, V_{dec}>V_{eq}.

Thus, the system according to the invention provides to switch off, i.e. for to open, the bypass circuit for each storage device when the majority or the entirety of the bypass circuits are in a switched-on state, i.e. a closed state. Thus, the system according to the invention makes it possible to prevent the storage devices from remaining bypassed, by current diversion circuits, after a charging phase. The system according to the invention hence makes it possible to prevent the storage devices from discharging into the bypass circuits, and in particular into bypass resistors of said bypass circuits, between a charging phase and a discharging phase.

As a result, the system according to the invention makes it possible to achieve more efficient balancing, to reduce energy losses and to improve the efficiency and autonomy of the storage assembly.

In addition, control of the bypass circuit for each storage device is performed individually by a second comparator that is dedicated to said storage device. As a result, the system according to the invention has great flexibility, but also increased robustness. Specifically, a malfunction in a second comparator associated with one storage device will not have any effect on the balancing of another storage device.

In the present application, “capacitive-effect storage device”, also called “storage device”, is understood to mean a device comprising, or formed of, one or more supercapacitors connected to one another in series or in parallel.

In the majority of cases, but without limitation, the capacitive-effect storage devices each comprise a single supercapacitor and have one and the same balancing voltage and one and the same switch-off voltage.

According to one configuration, the first comparator directly receives the voltage Vᵢ on the terminals of the storage device. In this case, the first comparator directly compares the voltage Vᵢ with the balancing voltage V_{eq}.

Alternatively, a first voltage divider may be used to adjust the voltage Vᵢ at the input of the first comparator. The first comparator then receives an input voltage Vᵢ^{E1}, such that Vᵢ^{E1}=Vᵢ/Dᵢ¹, where Dᵢ¹ is the coefficient of division applied by the first voltage divider. In this case, the first comparator compares the voltage Vᵢ^{E1} with a first voltage, called first reference voltage, denoted V_{ref1} and chosen such that V_{ref1}=V_{eq}/Dᵢ¹.

According to one configuration, the second comparator directly receives the voltage Vᵢ on the terminals of the storage device. In this case, it directly compares the voltage Vᵢ with the switch-off voltage V_{dec}.

Alternatively, a second voltage divider may be used to adjust the voltage Vᵢ at the input of the second comparator. The second comparator then receives an input voltage Vᵢ^{E2} such that Vᵢ^{E2}=Vᵢ/Dᵢ², where Dᵢ² is the coefficient of division applied by the second voltage divider. In this case, the second comparator compares the voltage Vᵢ^{E2} with a second voltage, called second reference voltage, denoted V_{ref2} and chosen such that V_{ref2}=V_{dec}/Dᵢ².

In one particularly advantageous configuration, the first and second voltage dividers may be dimensioned such that:

V_{ref1}=V_{ref2}=V_{ref}.

In this case, we have:

V_{dec}/Dᵢ²=V_{eq}/Dᵢ¹,

V_{dec}/V_{eq}=Dᵢ²/Dᵢ¹.

According to one non limiting exemplary implementation, each voltage divider may be formed by resistor bridges.

Moreover, considering that the capacitors of each storage device to be balanced are of between a minimum value Cₘᵢₙ and a maximum value Cₘₐₓ, V_{dec} may be taken such that:

$$\frac{{V}_{dec}}{{V}_{eq}} = \frac{{C}_{max}}{{C}_{min}}$$

More generally, it is possible to set a standard range of variation for the capacitors [C=C̅ (1±ΔC), where ΔC<<1, typically ΔC≤10%] and to set V_{dec} such that:

$${V}_{dec} = \frac{1 + Δ C}{1 - Δ C} {V}_{eq} \approx ( 1 + 2 Δ C ) {V}_{eq}$$

Moreover, V_{dec} must be lower than the maximum operating voltage, denoted Vₘₐₓ, of the storage device, in particular provided by the application.

According to one particularly advantageous feature, for at least one, in particular each, storage device, at least one of the first and second comparators may be referenced to the potentials on the terminals of said storage device, and be configured to supply, as output:
in a first state: the smallest potential, denoted Vᵢ⁻, on the terminals of said storage device; and
in a second state: the greatest potential, denoted Vᵢ⁺, on the terminals of said storage device.

The comparator(s) thus adjust(s) to the variation, over time, in the voltage across the terminals of the storage device, thereby making it possible to achieve a more efficient and more precise balancing.

In addition, it is not necessary to provide an additional voltage source for referencing the comparator(s), thereby reducing the cost and the bulk of the system according to the invention.

Finally, the comparator(s) operate(s) in a voltage range that does not exceed the maximum voltage across the terminals of each storage device, thereby enabling the use of less expensive and less bulky components in comparison with components operating at a very high voltage.

Advantageously, the system according to the invention may comprise, for at least one, in particular each, storage device:
a voltage divider, called first voltage divider, supplying, to the first comparator, a first input voltage that is proportional to and lower than said voltage on the terminals of said storage device; and/or
a voltage divider, called second voltage divider, supplying, to the second comparator, a second input voltage that is proportional to and lower than said voltage on the terminals of said storage device.

A voltage divider makes it possible to adjust, in particular to reduce, the voltage across the terminals of the storage device, so as to use a commercially available voltage source for the comparison performed by the first comparator, respectively the second comparator.

Indeed, from a practical point of view, the analogue electronic voltage sources have determined and set values. They therefore do not necessarily correspond to the value of the desired balancing voltage V_{eq}, respectively to the value of the desired switch-off voltage V_{dec}.

Advantageously, for at least one storage device, the voltage divider(s) may be dimensioned such that the first and second comparators perform a comparison of the input voltages at one and the same reference voltage, in particular supplied by one and the same single source.

The cost and bulk of the balancing system are thus reduced.

In this case, the voltage divider(s) may be chosen such that:

V_{dec}/V_{eq}=Dᵢ²/Dᵢ¹

where Dᵢ¹ and Dᵢ² are the coefficient applied by the first voltage divider and by the second voltage divider, respectively.

In all of the applications, V_{dec}>V_{eq}. Thus, in one particular embodiment, only the second voltage divider may be used, with a coefficient Dᵢ² such that:

V_{dec}/V_{eq}=Dᵢ²

In addition, at least one, and in particular each, of the first and second comparators may be a hysteresis comparator.

Such a hysteresis comparator makes it possible to prevent erratic changes of state by the control signal supplied by said comparator.

In a first exemplary implementation, at least one, in particular each, bypass circuit may comprise two switches, in series in said bypass circuit, one controlled depending on the voltage supplied by the first comparator and the other controlled depending on the voltage supplied by the second comparator.

Alternatively, or in addition, at least one, in particular each, bypass circuit may comprise a single switch, the balancing device furthermore comprising a means for controlling said single switch depending on the voltages supplied by the first and second comparators.

The cost, power consumption and bulk of the system according to the invention are thus reduced.

According to a exemplary implementation, for at least one, in particular each, balancing device, the means for controlling the single switch may comprise:
a transistor that is in the off, or blocked, state by default, for example an NPN bipolar transistor, in particular when the second comparator is an inverting comparator, or
a transistor that is in the on state by default, for example a PNP bipolar transistor, in particular when the second comparator is a non-inverting comparator.

In the case where a bipolar transistor is used, the base of said bipolar transistor is connected to the second comparator, the collector to the first comparator and the emitter to the single switch.

In this case, the voltage of the emitter of the transistor, denoted Vᵢ^{c}, may be used to control the single switch associated with the storage device.

According to one particularly advantageous feature, the system according to the invention may furthermore comprise a device for monitoring the operation of said balancing system, and possibly signal an operating fault in said system.

According to a first embodiment, the monitoring device may perform monitoring of the operation of said balancing system depending on the voltages supplied by the second comparators.

Such a device may be designed to take a weighted sum of all of the voltages supplied by the second comparators of all of the storage devices and compare the weighted sum obtained with a first threshold voltage, using a voltage comparator for example.

This first threshold voltage may be the voltage V across the terminals of the storage assembly, that is to say V=Vₙ⁺−V₁⁻.

It is also possible to take into account, in the first threshold voltage, a voltage δV representing a safety margin. In this case, the threshold voltage may be equal to: V−δV.

Alternatively, the voltage δV representing a safety margin may be added to the weighted sum.

According to a second embodiment, and when the bypass circuit of each balancing device comprises a single switch controlled by a control means, the monitoring device may perform monitoring of the operation of said balancing system depending on the control voltages of said single switches of all of the balancing devices.

Such a device may be designed to take a weighted sum of all of the control voltages and compare the sum obtained with a second threshold voltage, using a voltage comparator for example.

This second threshold voltage may be the voltage V across the terminals of the storage assembly, that is to say V=Vₙ⁺−V₁⁻.

It is also possible to take into account, in the second threshold voltage, a voltage δV representing a safety margin. In this case, the threshold voltage may be equal to: V−δV.

Alternatively, the voltage δV representing a safety margin may be added to the weighted sum.

According to a third embodiment, and when the bypass circuit for each balancing device comprises a single switch controlled by a means for controlling said single switch, the device for monitoring the operation of said system may perform monitoring depending on:
the control voltage of said single switch, and
the voltage supplied by the first comparator;
of each balancing device.

In particular, in one non limiting exemplary implementation of this third embodiment, the monitoring device may comprise, for each balancing device:
a controllable switch, called third switch, and
a comparator, called third comparator, for controlling said third switch.

All of the third switches may be connected to one another in series between two different electrical potentials, such as for example the potentials V₁⁻ and Vₙ⁺ on the terminals of the storage assembly.

Each third comparator, associated with a balancing device, performs a comparison of:
the control voltage of the single switch of the balancing device, and
the voltage supplied by the first comparator of said balancing device; for controlling the third switch that is associated therewith, depending on said comparison.

Each pair (third switch+third comparator) associated with a balancing device may be configured such that the third switch is controlled into a closed state when the single switch of said balancing device changes to a closed state.

In particular:
each 3^{rd} comparator may be an inverting comparator, or respectively a non-inverting comparator; and
each 3^{rd} switch may be a transistor that is in the off, or the blocked, state by default, for example an NPN bipolar transistor, or respectively a transistor that is in the on state by default, for example a PNP bipolar transistor.

According to another aspect of the same invention, a rechargeable electrical energy storage module is proposed, comprising:
at least one rechargeable electrical energy storage assembly, each comprising a plurality of capacitive-effect electrical energy storage devices connected to one another in series within said assembly, and
for at least one, in particular each, storage assembly, a balancing system according to the invention.

The energy storage module may comprise a plurality of storage assemblies.

At least two, in particular all, of the assemblies may be arranged in series with one another. Alternatively, or in addition, at least two, in particular all, of the assemblies may be arranged in parallel with one another.

At least two, in particular all, of the assemblies may comprise an identical number, or a different number, of storage devices.

According to another aspect of the present invention, a hybrid or electric transport vehicle is proposed, comprising one or more rechargeable electrical energy storage module(s) according to the invention.

“Transport vehicle” is understood to mean any type of means for transporting people or objects, such as a bus, a car, a tram, a boat, a lorry, a cable car, a lift, a goods lift, a crane, etc.

According to yet another aspect of the same invention, an electrical installation is proposed, comprising one or more rechargeable electrical energy storage module(s) according to the invention.

Such an electrical installation may be an electric charging station for electric or hybrid transport vehicles, or a power supply station for a building, for a complex or for an electric/electronic communication device.

Such an electrical installation may be a station for regulating or smoothing, or else buffer storing, electrical energy, for example supplied by an electricity grid or means for producing electricity. Such a regulating or smoothing station makes it possible to store surplus electrical energy during a period of low consumption, respectively high production, and to deliver the stored electrical energy during a period of high consumption, respectively low production.

The installation according to the invention may advantageously comprise a means for producing electrical energy from a renewable source, such as at least one solar panel and/or at least one wind turbine and/or at least one tidal turbine.

The energy produced by such a means may be used to recharge at least one rechargeable electrical energy storage module.

Alternatively, or in addition, at least one rechargeable electrical energy storage module may be recharged from the mains.

### DESCRIPTION OF THE FIGURES AND EMBODIMENTS

Other advantages and features will emerge upon examination of the detailed description of entirely nonlimiting embodiments, and of the appended drawings, in which:

FIGS. 1a and 1b show basic overviews of two exemplary implementations of a balancing system with controlled resistance according to the prior art;

FIG. 2 is a depiction of the basic overview of a first exemplary implementation of a balancing system with controlled resistance according to the invention;

FIG. 3 is a depiction of the basic overview of a second exemplary implementation of a balancing system with controlled resistance according to the invention;

FIG. 4 is a schematic depiction of a nonlimiting exemplary implementation of a module for monitoring the operation of a system according to the invention;

FIG. 5 is a schematic depiction of another nonlimiting exemplary implementation of a module for monitoring the operation of a system according to the invention;

FIG. 6 is a schematic depiction of a nonlimiting exemplary implementation of a storage module according to the invention; and

FIGS. 7a-7d are nonlimiting exemplary implementations of a capacitive-effect electrical energy storage device.

It is readily understood that the embodiments that will be described hereinafter are in no way limiting. It will be possible in particular to imagine variants of the invention comprising only a selection of features described hereinafter, in isolation from the other features described, if this selection of features suffices to afford a technical advantage or to differentiate between the invention and the prior art. This selection comprises at least one preferably functional feature without structural detail, or with only a portion of the structural details if this portion alone suffices to afford a technical advantage or to differentiate between the invention and the prior art.

In the figures, elements common to a plurality of figures retain the same reference.

In the following examples, but in a manner that is in no way limiting for the invention, all of the storage devices DCᵢ are considered to be identical and to have the same balancing voltage V_{eq}. Of course, the invention is not limited to these examples, and it is possible to use storage devices DCᵢ that are different from one another and that do not have the same balancing voltage.

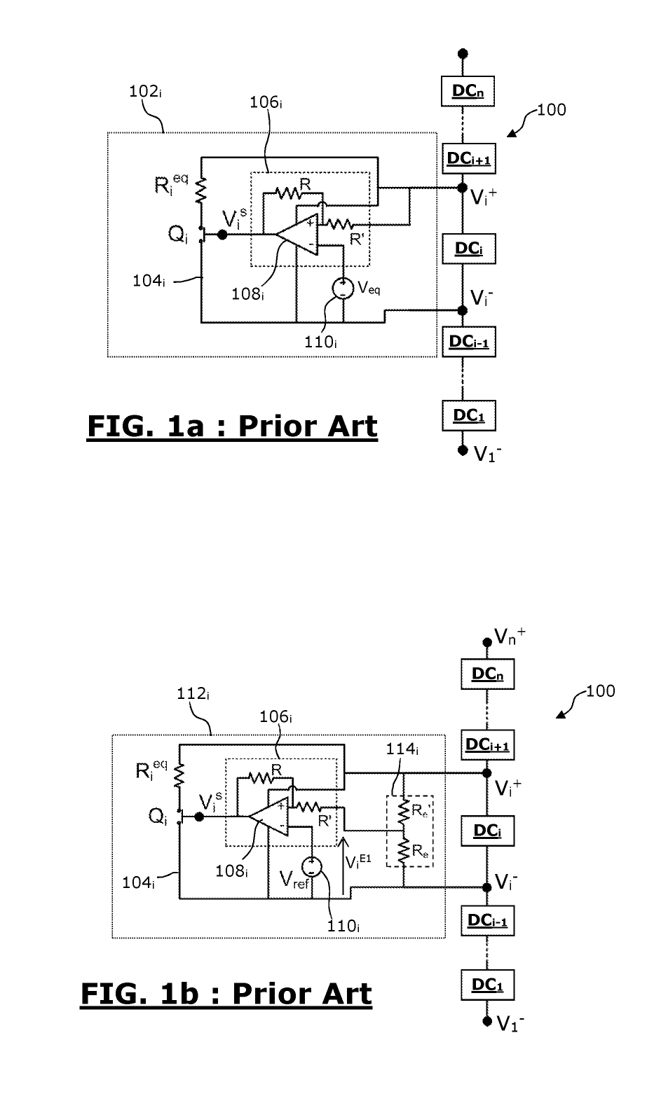

FIGS. 1a and 1b are depictions of the basic circuit diagrams of two examples of a balancing system with controlled resistance according to the prior art.

FIGS. 1a and 1b show a storage assembly 100 comprising n capacitive-effect storage devices DC₁, . . . , DCₙ that are connected to one another in series and are identical. The storage device DC₁ is situated on the side of the smallest electrical potential, denoted V₁⁻, of the storage assembly 100, and the storage device DCₙ is situated on the side of the greatest electrical potential, denoted Vₙ⁺, of the storage assembly 100. The voltage between the terminals of the storage device DCᵢ is denoted Vᵢ, and the voltage between the terminals of the storage assembly 100 is denoted V.

The system shown in FIGS. 1a and 1b comprises a balancing device with controlled resistance that is associated with each storage device DCᵢ.

Hereinafter, so as not to overload the drawings, only the balancing device 102ᵢ, associated with the storage device DCᵢ is shown in FIGS. 1a and 1b. The balancing devices of the other storage devices of the storage assembly 100 are on the same principle as the balancing device 102ᵢ, shown in FIGS. 1a and 1b, and are in particular identical to the balancing device 102ᵢ in the case where the storage devices DCᵢ have one and the same balancing voltage V_{eq}.

The balancing device 102ᵢ comprises a bypass circuit 104ᵢ, connected in parallel to the terminals of the storage device DCᵢ and including a switch Qᵢ in series with a balancing resistor Rᵢ^{eq}.

The balancing device 102ᵢ also comprises a hysteresis comparator 106ᵢ, called first comparator, for controlling the state of the switch Qᵢ. The first comparator 106ᵢ is formed by an operational amplifier 108ᵢ and two resistors R and R′, the values of which resistors set the width of the hysteresis. The resistors R and R′ are chosen so as to be large enough for the current that passes through them to be negligible, typically R>10 kΩ and R′>10 kΩ.

The operational amplifier 108ᵢ is referenced to the potentials, Vᵢ⁺ and Vᵢ⁻, across the terminals of the storage device DCᵢ with which the balancing device 102ᵢ is associated.

In the example shown in FIG. 1a, the positive input (+) of the operational amplifier 108ᵢ is connected to the greatest potential Vᵢ⁺ across the terminals of the storage device DCᵢ with which the balancing device 102ᵢ is associated. The negative input (−) of the operational amplifier 108ᵢ is connected to a voltage source 110ᵢ that is itself referenced to the smallest potential Vᵢ⁻ across the terminals of the storage device DCᵢ.

In the example shown in FIG. 1a, the voltage source 110ᵢ supplies the balancing voltage V_{eq} at which it is desired to bypass the storage device DCᵢ.

In this case, the comparator 106ᵢ directly compares the voltage Vᵢ across the terminals of the storage device DCᵢ with the balancing voltage V_{eq}, and operates in the following manner:
if Vᵢ (=Vᵢ⁺−Vᵢ⁻)<V_{eq}, then the voltage supplied by the first comparator 106ᵢ denoted Vᵢ^{s}, is equal to Vᵢ⁻ (=−Vₛₐₜ local): in other words, if the voltage Vᵢ across the terminals of the storage device DCᵢ is lower than the balancing voltage V_{eq}, then Vᵢ^{s}=Vᵢ⁻; and
if Vᵢ (=Vᵢ⁺−Vᵢ⁻)≥V_{eq}, then Vᵢ^{s}=Vᵢ⁺ (=+Vₛₐₜ local).

The voltage Vᵢ^{s} is used to control the switch Qᵢ into a closed state or into an open state.

In the example shown in FIG. 1a, the switch Qᵢ may be an N-channel MOSFET transistor, the gate of which receives the voltage Vᵢ^{s}:
when Vᵢ^{s} has the value Vᵢ⁻ (that is, when the voltage Vᵢ across the terminals of the storage device DCᵢ is lower than the balancing voltage V_{eq}), then the gate-source voltage is zero and the switch Qᵢ is in the off state/open: the bypass circuit 104ᵢ is open and does not draw any current; and
when Vᵢ^{s} has the value Vᵢ⁺ (that is, when the voltage Vᵢ across the terminals of the storage device DCᵢ is greater than or equal to the balancing voltage V_{eq}), then the gate-source voltage is non-zero and the switch Qᵢ is in the on state/closed: the bypass circuit 104ᵢ is closed and draws current that flows into the balancing resistor Rᵢ^{eq}.

FIG. 1b provides another exemplary implementation of a balancing device with controlled resistance. The balancing device 112ᵢ of FIG. 1b comprises a voltage divider 114ᵢ arranged as a diversion to the terminals of the storage device DCᵢ and formed by resistors Rₑ and Rₑ′. The voltage divider 114ᵢ is used to adjust the voltage Vᵢ (Vᵢ=Vᵢ⁺−Vᵢ⁻) across the terminals of the storage device DCᵢ. Indeed, from a practical point of view, the analogue electronic voltage sources have determined and set values. They therefore do not necessarily correspond to the value of the desired balancing voltage V_{eq} for the storage device DCᵢ. The comparator 106ᵢ thus receives, as input, not the voltage Vᵢ but an input voltage Vᵢ^{E1} such that Vᵢ^{E1}=Vᵢ/D¹, where D¹ is the coefficient of division applied by the voltage divider 114ᵢ, such that:

$${D}^{1} = \frac{{R}_{e} + {R}_{e}^{′}}{{R}_{e}}$$

In this case, the source 110ᵢ supplies not the balancing voltage V_{eq}, but a reference voltage, denoted V_{ref}, such that V_{ref}=V_{eq}/D¹.

In other words, we have:

$$\frac{{R}_{e}}{{R}_{e} + {R}_{e}^{′}} = \frac{{V}_{ref}}{{V}_{eq}}$$

In other words, in the exemplary implementation shown, V_{ref}≠V_{eq}, and

$${V}_{ref} = {V}_{eq} ( \frac{{R}_{e}}{{R}_{e} + {R}_{e}^{′}} )$$

The balancing device 112ᵢ, shown in FIG. 1b, moreover comprises all of the elements of the balancing device 102ᵢ of FIG. 1a.

Unlike the device 102ᵢ of FIG. 1a, in the device 112ᵢ of FIG. 1b, the positive input (+) of the operational amplifier 108ᵢ is connected to said voltage divider 114ᵢ. The resistors Rₑ and Rₑ′ forming the voltage divider are chosen so as to be large enough for the current that passes through them to be negligible, typically Rₑ>10 kΩ and Rₑ′>10 kΩ.

In this case, the voltage comparator 106ᵢ performs a comparison:
of the reference voltage V_{ref} (rather than the voltage V_{eq})
with the input voltage Vᵢ^{E1}, supplied by the voltage divider 114ᵢ.

In the examples described, the comparator 106ᵢ is a hysteresis comparator. Alternatively, the comparator 106ᵢ might not be a hysteresis comparator.

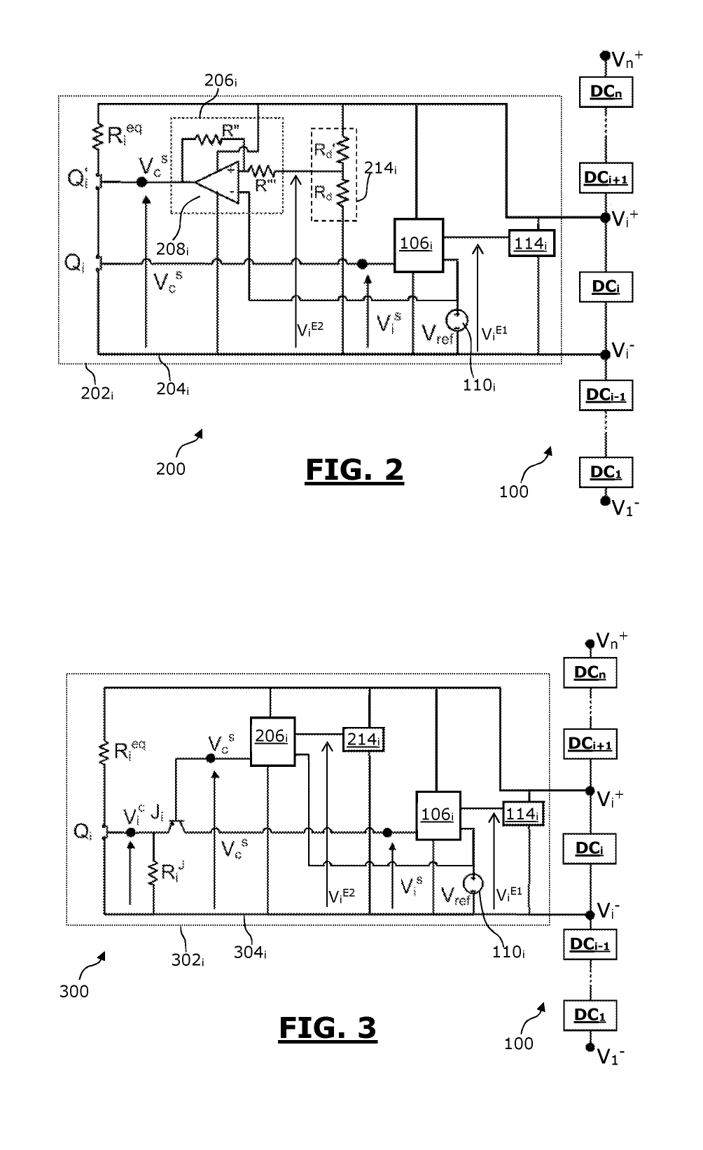

FIG. 2 is a depiction of the basic overview of a first non limiting exemplary implementation of a balancing system according to the invention.

The balancing system 200 of FIG. 2 comprises, for each storage device DC₁, . . . , DCₙ, an identical balancing device with controlled resistance, since the storage devices DC₁, . . . , DCₙ are identical.

So as not to overload the drawing, only the balancing device 202ᵢ, associated with the storage device DCᵢ, is shown in FIG. 2.

The balancing device 202ᵢ comprises a bypass circuit 204ᵢ for the storage device DCᵢ comprising the balancing resistor Rᵢ^{eq} in series with the switch Qᵢ. The bypass circuit 204ᵢ additionally comprises a second switch Qᵢ′, in series with the first switch Qᵢ.

In the same manner as in the balancing device 112ᵢ of FIG. 1b, the first switch Qᵢ is controlled by the voltage Vᵢ^{s} supplied by the comparator 106ᵢ, with the use of the voltage divider 114ᵢ.

The switch Qᵢ is a switch positioned in an open state/in the off state as long as the voltage across the terminals of the storage device DCᵢ has not reached the balancing voltage V_{eq}, and is otherwise closed/in the on state.

In the system 200 of FIG. 2, each balancing device 202ᵢ furthermore comprises a second switch Qᵢ′ in series with the first switch Qᵢ and the balancing resistor Rᵢ^{eq}. The switch Qᵢ′ is chosen and is controlled such that it remains closed/in the on state as long as the voltage Vᵢ across the terminals of the storage device DCᵢ has not reached a predetermined switch-off voltage, denoted V_{dec}, that is greater than the balancing voltage V_{eq}, and is otherwise open/in the off state.

Each balancing device 202ᵢ furthermore comprises a second voltage comparator 206ᵢ for controlling the switch Qᵢ′. The comparator 206ᵢ is a hysteresis comparator. In particular, the second comparator 206ᵢ is formed by an operational amplifier 208ᵢ and two resistors R″ and R′″, the values of which resistors set the width of the hysteresis. The resistors R″ and R′″ are chosen so as to be large enough for the current that passes through them to be negligible, typically R″>10 kΩ and R′″>10 kΩ.

The operational amplifier 208ᵢ is referenced to the potentials, Vᵢ⁺ and Vᵢ⁻, across the terminals of the storage device DCᵢ with which the balancing device 202ᵢ is associated.

In the example shown in FIG. 2, the positive input (+) of the operational amplifier 208ᵢ receives an input voltage, denoted Vᵢ^{E2}, that is proportional to the voltage across the terminals of the storage device DCᵢ through a voltage divider 214ᵢ formed by resistors R_{d} and R_{d}′. The negative input (−) of the operational amplifier 208ᵢ is connected to the voltage source 110ᵢ, supplying the reference voltage V_{ref}, which is itself referenced to the smallest potential, denoted Vᵢ⁻, across the terminals of the storage device DCᵢ.

As a result, the second voltage divider 214ᵢ supplies a voltage Vᵢ^{E2} such that Vᵢ^{E}=Vᵢ/D², where D² is the coefficient of division applied by the voltage divider 214ᵢ, such that:

$${D}^{2} = \frac{{R}_{d} + {R}_{d}^{′}}{{R}_{d}}$$

The voltage divider 214ᵢ must be dimensioned such that the coefficient D² satisfies the following relationship:

$${D}^{2} = \frac{{V}_{dec}}{{V}_{ref}}$$

In this case, the second voltage comparator 206ᵢ performs a comparison:
of the reference voltage V_{ref} delivered by the source 110ᵢ, with the second input voltage Vᵢ^{E2}, supplied by the voltage divider 214ᵢ.

Thus, in the exemplary implementation shown in FIG. 2, the reference voltages used by the two comparators 106ᵢ and 206ᵢ are identical. However, for a given voltage across the terminals of the storage device DCᵢ, the input voltage Vᵢ^{E1} used by the first comparator 106ᵢ for the comparison with the reference voltage V_{ref} is greater than that Vᵢ^{E2} used by the second comparator 206ᵢ. Thus, the switch-off level V_{dec} of the switch Qᵢ′ is greater than the switch-on level V_{eq} of the switch Qᵢ.

The second comparator 206 operates in the following manner:
if the second input voltage Vᵢ^{E}<V_{ref}, this means that Vᵢ<V_{dec}: in this case the voltage supplied by the second comparator 206ᵢ, denoted V_{c}^{s}, is equal to Vᵢ⁻ (=−Vₛₐₜ local); and
if the second input voltage Vᵢ^{E2}≥V_{ref}, this means that Vᵢ≥V_{dec}: in this case the voltage V_{c}^{s} supplied by the second comparator 206ᵢ is equal to Vᵢ⁺ (=+Vₛₐₜ local).

In these conditions, the switch Qᵢ′ may be a P-channel MOSFET transistor, the gate of which receives the voltage V_{c}^{s}:
when V_{c}^{s} has the value Vᵢ⁻, this means that the voltage Vᵢ has not reached the switch-off voltage V_{dec}, then the gate-source voltage is zero and the switch Qᵢ′ is closed/in the on state: the bypass circuit 204ᵢ is closed: the storage device DCᵢ is bypassed depending on the state of the switch Qᵢ; and
when V_{c}^{s} has the value Vᵢ⁺, this means that the voltage Vᵢ has reached the switch-off voltage V_{dec}, then the gate-source voltage is positive and, as a result, the switch Qᵢ′ is in the off state/open: the bypass circuit 204ᵢ is open regardless of the state of the switch Qᵢ and does not draw current: the storage device DCᵢ is not bypassed.

FIG. 3 is a depiction of the basic overview of a second nonlimiting exemplary implementation of a balancing system according to the invention.

The balancing system 300 of FIG. 3 comprises the first comparator 106ᵢ and the second comparator 206ᵢ of the system 200 of FIG. 2.

The balancing system 300 furthermore comprises, for each storage device DC₁, . . . , DCₙ, an identical active balancing device with controlled resistance.

So as not to overload the drawing, only the balancing device 302ᵢ, associated with the storage device DCᵢ, is shown in FIG. 3.

The balancing device 302ᵢ comprises a bypass circuit 304ᵢ for the storage device DCᵢ, comprising the balancing resistor Rᵢ^{eq} in series with a single switch, namely the switch Qᵢ. In the system 300, the switch Qᵢ is controlled depending both on the voltage Vᵢ^{s} supplied by the first comparator 106ᵢ and on the voltage V_{c}^{s} supplied by the second comparator 206ᵢ.

To this end, the balancing device 302ᵢ comprises a control means receiving, on the one hand, the voltage Vᵢ^{s} supplied by the first comparator 106ᵢ and, on the other hand, the voltage V_{c}^{s} supplied by the second comparator 206ᵢ. In particular, the control means is a bipolar transistor, denoted Jᵢ, such as a PNP bipolar transistor that is closed/in the on state by default, and connected such that:
the base of the transistor Jᵢ receives the voltage V_{c}^{s},
the collector of the transistor Jᵢ receives the voltage Vᵢ^{s} and
the emitter of the transistor Jᵢ controls the switch Qᵢ, through a control voltage denoted Vᵢ^{c}.

As described above, the switch Qᵢ may be an N-channel MOSFET transistor.

In these conditions, the switch Qᵢ of the bypass circuit 304ᵢ is controlled in the following manner:
if the voltage Vᵢ across the terminals of the storage device DCᵢ has not reached the balancing voltage V_{eq}, then Vᵢ^{s}=Vᵢ⁻ and V_{c}^{s}=Vᵢ⁻. As a result, the bipolar transistor Jᵢ is in the on state/closed and the voltage Vᵢ⁻ arrives at the switch Qᵢ, which is then in the off state/open: the bypass circuit 304ᵢ does not allow the current to flow;
if the voltage Vᵢ across the terminals of the storage device DCᵢ has reached the balancing voltage V_{eq}, but not the switch-off voltage V_{dec}, then Vᵢ^{s}=Vᵢ⁺ and V_{c}^{s}=Vᵢ⁻. As a result, the bipolar transistor Jᵢ is in the on state and the voltage Vᵢ⁺ arrives at the switch Qᵢ, which is then in the on state/closed: the bypass circuit 304ᵢ allows the current to flow and the storage device DCᵢ is bypassed; and
if the voltage Vᵢ across the terminals of the storage device DCᵢ has reached the switch-off voltage V_{dec}, then Vᵢ^{s}=Vᵢ⁺ and V_{c}^{s}=Vᵢ⁺. As a result, the bipolar transistor Jᵢ is in the off state and the voltage Vᵢ⁻ arrives at the switch Qᵢ through a resistor Rᵢ^{j} connecting the gate of the switch Qᵢ to the potential Vᵢ⁻. The switch Qᵢ is then in the off state/open: the bypass circuit 304ᵢ is open and does not allow the current to flow.

Alternatively to what is described in FIGS. 2 and 3, it is possible to use a second comparator that is not a hysteresis comparator.

It is also possible to use an individual voltage source for each comparator. The individual voltage sources may supply one and the same reference voltage or different reference voltages.

According to another alternative, it is possible to use a second comparator that is an inverting comparator. In this case, the second switch Qᵢ′ may be for example an N-channel MOSFET transistor and the control means Jᵢ may be an NPN bipolar transistor.

According to another alternative, it is possible not to use a voltage divider for the first comparator, as shown in FIG. 1a. In this case, the first comparator receives, as input, and compares with one another:
the voltage Vᵢ across the terminals of the storage device DCᵢ and
the balancing voltage V_{eq}.

Alternatively or in addition, it is possible not to use a voltage divider for the second comparator. In this case, the second comparator receives, as input, and compares with one another:
the voltage Vᵢ across the terminals of the storage device DCᵢ and
the switch-off voltage V_{dec}.

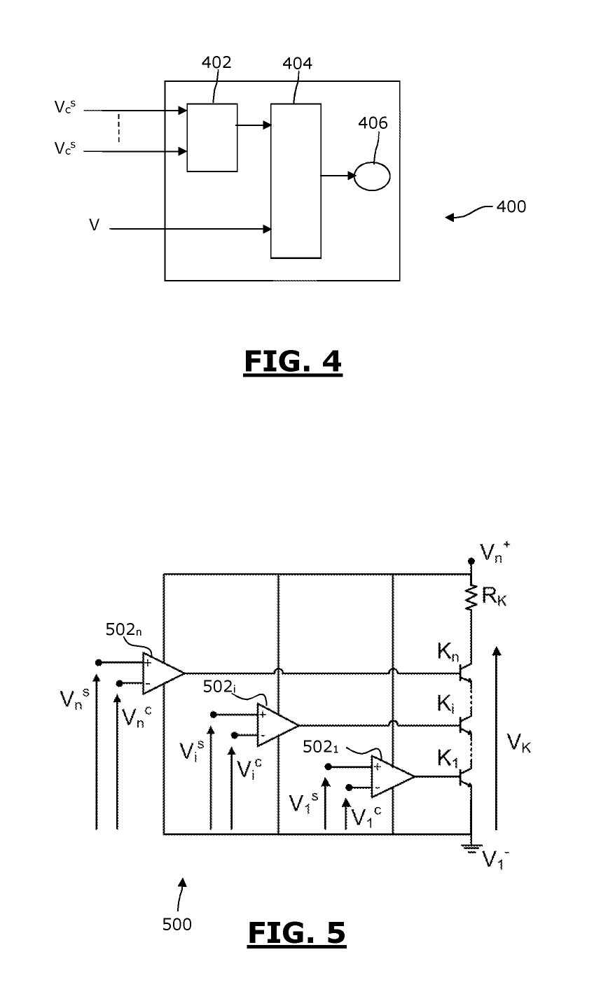

FIG. 4 is a schematic depiction of an exemplary implementation of a monitoring module able to be implemented in the system according to the invention, and in particular in the system 200 of FIG. 2.

The monitoring module 400, shown in FIG. 4, takes as input, for each balancing device 202ᵢ, the control voltage V_{c}^{s} supplied by the second comparator 206ᵢ and the voltage Vᵢ.

It will be recalled that each voltage V_{c}^{s}=Vᵢ⁻ when the bypass circuit has not been switched off, and V_{c}^{s}=Vᵢ⁺ in the opposite case.

The monitoring module 400 comprises a weighted summer 402 taking a weighted sum of all of the V_{c}^{s}.

The monitoring module 400 also receives the voltage V across the terminals of the storage assembly (V=Vₙ⁺−V₁⁻).

The monitoring module 400 furthermore comprises a voltage comparator 404 comparing the weighted sum voltage supplied by the weighted summer 402 with the voltage V across the terminals of the storage assembly.

As long as all of the bypass circuits have not all been switched off, the voltage supplied by the summer 402 will be lower than the voltage V across the terminals of the storage assembly. When all of the bypass circuits are switched off, the voltage supplied by the summer 402 will be equal to the voltage V across the terminals of the storage assembly.

The output of the comparator 404 may be used to signal the result of the comparison, for example with the aid of an indicator light 406 powered by the output of the comparator 404.

The comparator 404 may be referenced to the potentials (V₁⁻ and Vₙ⁺) across the terminals of the storage assembly 100.

Alternatively, the comparator 404 may compare the voltage supplied by the first summer 402 with a threshold voltage V_{threshold}, taking into account a voltage δV representing a safety margin, such that:

V_{threshold}=V−δV.

According to yet another alternative, the voltage δV representing a safety margin may be added to the weighted sum supplied by the summer 402, directly in said summer 402, or by another summer arranged in cascade with the summer 402.

The voltage δV representing a safety margin may be greater than or equal to 50 mV, this value typically representing the expected precision of the analogue electronics.

FIG. 5 is a schematic depiction of another exemplary implementation of a monitoring module able to be implemented in the system according to the invention, and in particular in the system 300 of FIG. 3.

The monitoring module 500 comprises, for each storage device DCᵢ, a comparator 502ᵢ, referenced to the potentials Vₙ⁺ and V₁⁻ across the terminals of the storage assembly 100 and receiving:
at its positive input, the voltage Vᵢ^{s} supplied by the first comparator 106ᵢ associated with said storage device DCᵢ and
at its negative input, the voltage Vᵢ^{c} supplied by the control means Jᵢ associated with said storage device DCᵢ.

Each comparator 502ᵢ therefore compares the voltages Vᵢ^{s} and Vᵢ^{c} such that, if Vᵢ^{s}≤Vᵢ^{c}, the output voltage of the comparator has the value V₁⁻, and, if Vᵢ^{s}>Vᵢ^{c}, the output voltage of the comparator has the value Vₙ⁺.

Each comparator 502ᵢ controls a switch, denoted Kᵢ, which may be for example an NPN bipolar transistor, and which is open by default and which is closed when the voltage supplied by the comparator is equal to Vₙ⁺.

The switches K₁, . . . , Kₙ, controlled by the comparators 502₁, . . . , 502ₙ, respectively, are connected to one another in series and to a resistor R_{K}, between the potentials Vₙ⁺ and V₁⁻.

Thus, when there is at least one switch Kᵢ that is open, then no current flows into the resistor R_{K}, and the voltage V_{K} at the negative terminal of the resistor R_{K} has the value Vₙ⁺, this corresponding to a high state (non-zero voltage with respect to V₁⁻). When all of the switches Kᵢ are closed, then a current flows through the resistor R_{K}, and the voltage V_{K} at the negative terminal of the resistor R_{K} has the value V₁⁻, this corresponding to a low state (zero voltage with respect to V₁⁻).

The resistor R_{K} is an arbitrary resistor with a value that is large enough, for example with a value of greater than 10 kΩ, to limit the current that passes through all of the switches K₁, . . . , Kₙ.

This voltage V_{K} may be used to monitor the operation of the balancing system, for example by turning on an indicator light (not shown in FIG. 5).

Alternatively, each comparator 502ᵢ may be local to the balancing device 302ᵢ of each storage device DCᵢ.

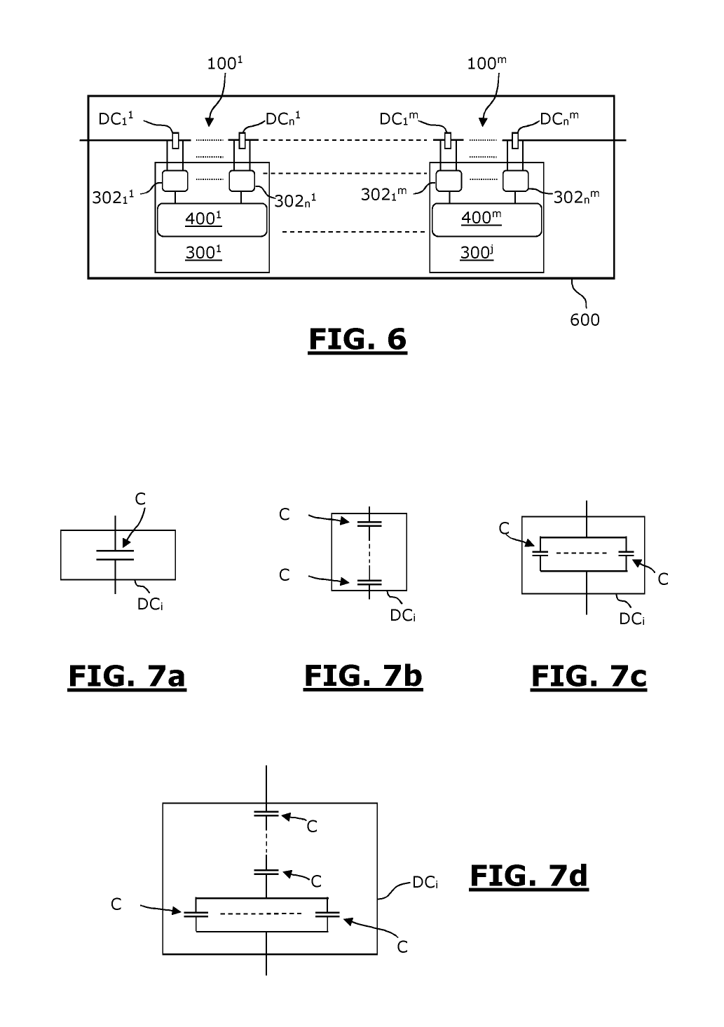

FIG. 6 is a schematic depiction of a non limiting exemplary implementation of a storage module according to the invention.

The storage module 600, shown in FIG. 6, comprises a plurality of storage assemblies 100¹, . . . , 100^{m} each comprising a plurality of storage devices connected to one another in series.

The assemblies 100¹, . . . , 100^{m} may be connected to one another in series or in parallel.

In the example shown, each assembly 100^{j} comprises “n” storage devices DC₁^{j}, . . . , DCₙ^{j}.

A balancing device 302ᵢ^{j}, such as for example the balancing device 302ᵢ of FIG. 3, is connected to each storage device DCᵢ^{j}, 1≤i≤n and 1≤j≤m.

A monitoring module 400^{j}, such as for example the monitoring module 400 of FIG. 4, is furthermore associated with each assembly 100^{j}.

The storage module 600 may be used in a rechargeable electric or hybrid transport vehicle, which may be a bus, a car, a tram, a boat, a lorry, a cable car, a goods lift, a crane, etc.

The storage module 600 may also be used in an electrical installation, which may be:
an electric charging station for electric or hybrid transport vehicles,
a power supply station for a building, for a complex or for an electric/electronic communication device, or
a station for regulating, smoothing or buffer storing electrical energy.

FIGS. 7a-7d are nonlimiting exemplary implementations of a capacitive-effect electrical energy storage device.

Each storage device DCᵢ may be any one of the storage devices described with reference to FIGS. 7a-7d.

The storage device DCᵢ shown in FIG. 7a comprises a single supercapacitor C. It is this device example that has been considered in the examples described above with reference to FIGS. 1-6.

Of course, the invention is not limited to this example.

For example, the storage device DCᵢ shown in FIG. 7b comprises a plurality of supercapacitors C connected in series.

The storage device DCᵢ shown in FIG. 7c comprises a plurality of supercapacitors C connected in parallel.

The storage device DCᵢ shown in FIG. 7d comprises a group of one of more supercapacitors C connected in series with a group of at least two supercapacitors connected in parallel with one another.

Of course, the invention is not limited to the examples described above.

1. An analogue system for balancing a rechargeable electrical energy storage assembly comprising a plurality of capacitive-effect storage devices connected to one another in series, said system comprising, for each storage device, a balancing device including:
a bypass circuit for said storage device, able to be controlled between a closed state and an open state; and
a voltage comparator, called first comparator, arranged to control said bypass circuit into an open or closed state depending on the voltage at the terminals of said storage device and on a predetermined voltage, called balancing voltage;
said system including for each storage device, another voltage comparator, called second comparator, designed to control an open or closed state of the bypass circuit for said storage device depending:
on the voltage on the terminals of said storage device; and
on a predetermined voltage, called switch-off voltage,
representative of a closed state of the majority, or of all, of the bypass circuits.

2. The system according to claim 1, characterized in that, for at least one, in particular each, storage device, at least one of the first and second comparators is referenced to the potentials on the terminals of said storage device, and is configured to supply, as output:
in a first state: the smallest potential on the terminals of said storage device; and
in a second state: the greatest potential on the terminals of said storage.

3. The system according to claim 1, characterized in that it comprises, for at least one, in particular each, storage device:
a voltage divider, called first voltage divider, supplying, to the first comparator, a first input voltage that is proportional to and lower than said voltage on the terminals of said storage device; and/or
a voltage divider, called second voltage divider, supplying, to the second comparator, a second input voltage that is proportional to and lower than said voltage across the terminals of said storage device.

4. The system according to claim 3, characterized in that, for at least one storage device, the voltage divider(s) is (are) dimensioned such that the first and second comparators perform a comparison of the input voltages at one and the same reference voltage, in particular supplied by one and the same single source.

5. The system according to claim 1, characterized in that at least one of the first and second comparators is a hysteresis comparator.

6. The system according to claim 1, characterized in that at least one, in particular each, bypass circuit comprises two switches in series, one controlled depending on the voltage supplied by the first comparator and the other controlled depending on the voltage supplied by the second comparator.

7. The system according to claim 1, characterized in that at least one, in particular each, bypass circuit comprises a single switch, the balancing device further comprising a means for controlling said single switch depending on the voltages supplied by the first and second comparators.

8. The system according to claim 7, characterized in that the control means comprises:
a transistor that is in the blocked state by default, for example an NPN bipolar transistor, in particular when the second comparator is an inverting comparator; or
a transistor that is in the on state by default, for example a PNP bipolar transistor, in particular when the second comparator is a non-inverting comparator.

9. The system according to claim 1, characterized in that it further comprises a device for monitoring the operation of said system depending on the voltages supplied by the second comparators of all of the storage devices.

10. The system according to claim 7, characterized in that it comprises a device for monitoring the operation of said system depending on the control voltages of the single switches of all of the bypass circuits.

11. The system according to claim 7, characterized in that it comprises a device for monitoring the operation of said system depending on:
the control voltages of all of the single switches, and
the voltages supplied by all of the first comparators.

12. A rechargeable electrical energy storage module, comprising:
at least one rechargeable electrical energy storage assembly, each comprising a plurality of capacitive-effect electrical energy storage devices connected to one another in series within said assembly; and
for at least one, in particular each, storage assembly, a balancing system according to claim 1.

13. An electric or hybrid transport vehicle comprising one or more rechargeable electrical energy storage modules according to claim 12.

14. An electrical installation, such as an electric charging station for electric or hybrid transport vehicles, or a power supply station for a building, for a complex or for an electric/electronic communication device, or a station for regulating or smoothing electrical energy, comprising one or more rechargeable electrical energy storage modules according to claim 12.
